(19) United States
(12) Patent Application Publication
(10) Pub. No.: US 2004/0179722 A1
(43) Pub. Date: Sep. 16, 2004

(54) Image sensing apparatus

(76) Inventors: Katsunori Moritoki, Osaka (JP); Tetsuro Otsuchi, Osaka (JP)

Correspondence Address: RATNERPRESTIA, P O BOX 980, VALLEY FORGE, PA, 19482-0980, US

(21) Appl. No.: 10/477,075

(22) PCT Filed: Sep. 30, 2002
(86) PCT No.: PCT/JP02/10155

(30) Foreign Application Priority Data
Oct. 2, 2001 (JP) 2001-306117
Oct. 19, 2001 (JP) 2001-321649

(51) Int. Cl. G06K 9/00; G02B 6/06

(52) U.S. Cl. 382/124; 385/116

(57) ABSTRACT

An image detecting device according to the invention is provided with an optical fiber array substrate 101, a circuit conductor layer 109 over it, an image sensor 106 arranged over the circuit conductor layer, first illuminating means 104 arranged so that the angle of incidence on the plane of incidence of the optical fiber be made greater than the critical angle and the direction of lights reflected by the plane of incidence relative to the direction of the optical axis of the optical fibers be made not greater than the critical angle of total reflection inside the optical fiber, second illuminating means 105 arranged so that the angle of incidence on the plane of incidence of the optical fiber be made smaller than the critical angle and the direction of lights reflected by the plane of incidence relative to the direction of the optical axis of the optical fibers be made not smaller than the critical angle of total reflection inside the optical fibers, and control means 110 which performs control for turning on or off each illuminating means, wherein the direction of the optical axes of the optical fibers is arranged with an inclination at a prescribed angle to the normal to said main face of said optical fiber array substrate.

### TECHNICAL FIELD

The present invention relates to an image detecting device for directly inputting as one-dimensional picture data an unevenness pattern formed on the surface of a soft object, such as a rubber stamp or a fingerprint for instance, and its gradational information.

### BACKGROUND ART

Typical devices for detecting a very small unevenness pattern, such as a fingerprint, according to the prior art include optical detecting devices. Among optical unevenness pattern detecting devices according to the prior art, ones using prisms are known (see, for instance, the Japanese Patent Laid-Open No. Sho 55-13446).

This example of the prior art, using a rectangular prism, has a configuration in which parallel lights are brought to incidence from a plane of incidence; these incident lights are totally reflected by an inclined plane of the rectangular prism, and emitted lights outputted from the plane of emission are picked up by a camera. When an object whose surface is uneven, such as a finger, comes into close contact with an inclined plane of a rectangular prism, the incident lights are totally reflected by concaves, but not by convexes by reason of the index of refraction. This effect provides distinct lightness and darkness due to the unevenness and thereby allows the unevenness pattern to be detected.

In an optical unevenness pattern detecting device of such a configuration, the light source and the camera should be arranged so that the incident lights radiated from the light source and the emitted lights to be picked up by the camera form a substantial right angle between them, and it is thereby made difficult to reduce the size of the unevenness detecting device.

As a configuration to solve this problem, an unevenness pattern detecting device using an optical fiber plate is known according to the prior art (see, for instance, the Japanese Patent Laid-Open No. Hei 6-3009.30).

The configuration of this unevenness pattern detecting device according to the prior art will be described below with reference to FIG. 23 and FIG. 24.

In FIG. 23, reference numeral 2301 denotes an optical fiber bundle; 2301a, the plane of incidence of the optical fiber bundle 2301; 2301b, the plane of emission of the optical fiber bundle 2301, the plane of incidence 2301a being inclined relative to the central axis of each optical fiber of the optical fiber bundle 2301 at a prescribed angle; 2302, illuminating means (e.g. an LED) and 2303, a parallel light flux (illuminating lights) projected from the illuminating means.

Next will be described the operation. First, the parallel light flux 2303 is projected from the illuminating means 2302. This parallel light flux 2303 is transmitted by the optical fiber bundle 2301 and reaches the plane of incidence 2301a.

In this case, the angle of incidence θ of the parallel light flux 2303 relative to the plane of incidence 2301a is supposed to be greater than the critical angle at the interface between the core part 2402 of the optical fiber and air.

Therefore, the reflected lights 2401 (see FIG. 24) at an angle of reflection θ are totally reflected by the plane of incidence 2301a being not in contact with the concaves of an object 2101 and not totally reflected by the plane of incidence 2301a being in contact with the convexes of the object 2101 because of the index of mutual refraction between media.

As this makes reflected lights in the parts where the concaves are not in contact more intense than reflected lights in the parts where the convexes are in contact, the reflected lights 2401 form a contrasty optical pattern matching the unevenness pattern. Since an image sensor 2105 is directly attached to the plane of emission 2301b, the image pickup face of the image sensor 2105 is either in direct contact with the plane of emission 2301b or arranged in the vicinity of the plane of emission 2301b.

Therefore, the optical pattern on the plane of emission 2301b is directly inputted to the image pickup face of the image sensor 2105. As described so far, the use of an optical fiber bundle can provide more freedom in optical path designs than where a prism is used because an optical fiber bundle can be bent, and is more suitable for size reduction.

FIG. 24 is a section showing an enlarged view of one of the optical fibers of the unevenness pattern detecting device shown in FIG. 23. In this drawing the angle between the plane of incidence and the optical axis of the fiber is defined.

In FIG. 24, reference numeral 2401 denotes positive reflected lights of the parallel light flux 2303 on the plane of incidence 2301a, the angle between the positive reflected lights 2401 and a normal 2405 to the plane of incidence being set to θ; 2402, the core part of one optical fiber of the optical fiber bundle 2301; 2403, a cladding; and 2404, the central axis of the optical fiber, the angle formed by the central axis 2404 and the normal 2405 to the plane of incidence 2301a being φ in the vicinity of the plane of incidence 2301a.

The central axis 2404 of the optical fiber in the vicinity of the plane of incidence 2301a is substantially parallel to the reflected lights 2401, and the angle φ formed by the normal 2405 to the plane of incidence 2301a and the central axis 2404 of the optical fiber satisfies the condition for the critical angle of total reflective propagation represented by (Formula 1) below so that the reflected lights 2401 can propagate within the optical fiber of the optical fiber bundle 2301 by total reflection.

θ−sin⁻¹(N.A./n core)≦φ≦θ+sin⁻¹(N.A./n core) (Formula 1)

In (Formula 1), n core is the index of refraction of the core part 2402 of the optical fiber, and N.A., the number of apertures of the optical fiber.

As a result of this, the reflected lights 2401 having the angle of reflection θ propagates in each optical fiber of the optical fiber bundle 2301. In this process, non-totally reflected lights propagate in the optical fibers with whose plane of incidence 2301a the convexes of the object 2101 are in contact, while totally reflected lights propagate in the optical fibers to whose plane of incidence 2301a the concaves are opposite.

Incidentally, in the unevenness pattern detecting device according to the prior art shown in FIGS. 23 and 24, illuminating lights 2303 radiated from the illuminating means 2302 cross the optical fiber bundle and are brought to incidence on the plane of incidence 2301a.

Of the unevenness pattern pressed against the plane of incidence, the plane of incidence is in contact with air in the concaves as shown in FIG. 24.

The angle θ formed by the direction of the normal 2405 of the plane of incidence and the incident illuminating lights is set to be not smaller than the critical angle of total reflection which the core 2402 of the fiber has relative to air.

This enables those concaves with which the unevenness pattern is not in close contact to satisfy the conditions for total reflection by the plane of incidence 2402; the illuminating lights 2303 are fully reflected, reflected at an angle of θ forming a normal in the direction reverse to the normal to the plane of incidence, and transmitted within the fiber as the fiber-transmitted lights 2401.

Further at this point, the direction of the optical axis of each optical fiber is so set that the angle formed by the optical axis 2404 of the optical fiber and the optical fiber-transmitted lights 2401 be not greater than the critical angle of total reflection within the optical fiber.

This causes the optical fiber-transmitted lights to be transmitted in the direction of the plane of emission 2301b while being totally reflected by the interface between the core 2402 and the cladding 2403 of the fiber. Thus, substantially the total luminous energy of the illuminating lights 2303 is brought to incidence on the image sensor on the plane of emission side, and undergoes photoelectric conversion by the image sensor to output electrical signals matching the luminous energy.

On the other hand, regarding the convexes of the unevenness pattern, as the core 2402 of the optical fiber is in close contact with the convexes of the unevenness pattern, the critical angle of total reflection differs from the critical angle relative to air, and accordingly the conditions for total reflection are not satisfied.

Then, the illuminating lights having irradiated the plane of incidence are transmitted by the plane of incidence, and irradiate the object 2101. The illuminating lights are scattered by the surface of or within the object 2101, part of them being again transmitted from the plane of incidence 2402 of the optical fiber to the fiber. Of the scattered lights transmitted into the fiber, moreover, only those within the range of the critical angle of total reflection inside the optical fiber are transmitted to the plane of emission via inside the fiber, and radiated from the fiber to the image sensor.

In this way, intense lights almost totally reflected by the concaves irradiate the image sensor, while part of weak light scattered by the convexes irradiate the image sensor, and an electrical output matching the unevenness pattern is supplied from the image sensor.

However, the above-described unevenness pattern detecting device using an optical fiber bundle involves the following problems.

As an illuminating light source is separately provided as shown in FIG. 23, overall size reduction of the device is difficult (a first problem).

Further, the image pickup element is provided normal to the optical axis of the optical fiber, and therefore the device cannot be shaped planarly. If the image pickup element is to be made vertical as shown in FIG. 23 to facilitate installation of the device, the optical fiber should be bent between the plane of incidence and the plane of emission. The optical fiber can be bent, but it not only is troublesome and accordingly constitutes a factor to raise the cost, but also there is an additional problem that a transmission loss would darken or distort the picture (a second problem).

In particular, it is difficult to make the device thin. It is also difficult to package the device on a plane and, if it is done at all, the package will be rather tall. Further, whereas the angle formed by the central axis of the optical fiber and the normal to the plane of incidence is defined by (Formula 1), this range is nothing more than a condition that the lights totally reflected by the plane of incidence are totally reflected in the core and propagate, and at the boundary of this condition the lights totally reflected by the plane of incidence only partly propagate within the optical fiber, entailing a problem that the efficiency of light utilization is poor and, moreover, the picture is darkened.

Incidentally, a microscopic view of the section of an object, such as a copy, reveals copying toner sticking to the paper surface as semicircular protrusions. For this reason, in the above-described configuration of the unevenness pattern detecting device according to the prior art, the toner protrusions and the core of the optical fiber come into point contact with each other, with the result that the area of the core of the optical fiber in optical close contact with the surface of the object is extremely small.

For this reason, the plane of incidence of the optical fiber satisfies the condition for total reflection, and the illuminating lights do not proceed from the plane of incidence to the object.

As a consequence, there is a problem that gradational information on the object and, furthermore, picture information on the object, such as copy, cannot be read by the same sensor (a third problem).

### DISCLOSURE OF THE INVENTION

The present invention is intended, in view of the third problem with the prior art stated above, to provide an image detecting device provided with, in the same detecting device, both a function to detect the unevenness pattern of the object and a function to detect picture information on the object.

A first invention of the present invention is an image detecting device comprising:

an optical fiber array substrate penetrated by a plurality of optical fibers of each of which one end face is the plane of incidence and the other is the plane of emission, and in which said plurality of optical fibers are arranged, main face of said optical fiber array substrate being a face containing said plane of emission,

a circuit conductor layer formed on said main face,

an image sensor arranged in a prescribed position on said circuit conductor layer,

first illuminating means so arranged as to make the angle of incidence of said optical fibers to said plane of incidence greater than a critical angle and a direction of lights reflected by said plane of incidence relative to a direction of the optical axes of said optical fibers not greater than a critical angle of total reflection within the optical fibers,

second illuminating means so arranged as to make the angle of incidence of said optical fibers to said plane of incidence smaller than the critical angle and the direction of lights reflected by said plane of incidence relative to the direction of the optical axes of said optical fibers not smaller than the critical angle of total reflection within the optical fibers, and

control means of performing control regarding turning on or off of said first and second illuminating means, wherein:

the direction of the optical axes of said optical fibers is arranged with an inclination by a prescribed angle to the normal to said main face of said optical fiber array substrate.

A second invention of the present invention is the image detecting device according to the first invention of the present invention wherein:

when only illuminating lights from said first illuminating means are caused to irradiate said plane of incidence by said control means, said image detecting device detects an unevenness pattern in which reflected lights from concaves of the unevenness pattern of an object of detection are more intense than reflected lights from convexes, said object of detection contacting with said plane of incidence.

A third invention of the present invention is the image detecting device according to the first or the second invention of the present invention wherein:

said first illuminating means is packaged face down over said main face with optically transmissive insulating resin intervening in-between.

A fourth invention of the present invention is the image detecting device according to the first invention of the present invention wherein:

when only illuminating lights from said second illuminating means are caused to irradiate said plane of incidence by said control means, said image detecting device detects reflected lights corresponding to gradation of unevenness pattern of an object of detection, said object of detection contacting with said plane of incidence.

A fifth invention of the present invention is the image detecting device according to the first or the second invention of the present invention wherein:

said second illuminating means is packaged face down over said main face with an optically transmissive insulating resin intervening in-between.

A sixth invention of the present invention is the image detecting device according to the first invention of the present invention wherein:

said control means selectively irradiates the planes of incidence of the optical fibers with illuminating lights from said first illuminating means and lights from said second illuminating means on a time-division basis.

A seventh invention of the present invention is the image detecting device according to any of the first to the sixth inventions of the present invention wherein:

said first illuminating means is arranged in a position away from a position on said main face opposite a substantially central position of said plane of incidence of said optical fiber array substrate by distance at least d×tan θ in the direction reverse to said plane of emission,

where d is the thickness of said optical fiber array substrate and θ is the critical angle of said optical fibers on said planes of incidence.

An eighth invention of the present invention is the image detecting device according to any of the first to the sixth inventions of the present invention wherein:

said second illuminating means is arranged in an area towards said plane of emission with reference to the position on said main face opposite the substantially central position of said plane of incidence of said optical fiber array substrate.

A ninth invention of the present invention is the image detecting device according to any of the first to the eighth inventions of the present invention wherein:

a light absorbing layer is formed over the surface of areas except an area in which said image sensor, said first illuminating means and said second illuminating means are arranged and an area of said plane of incidence and the plane of emission.

A tenth invention of the present invention is the image detecting device according to the eighth invention of the present invention wherein:

difference between an index of refraction of said absorbing layer and an index of refraction of said base glass of said optical fiber array substrate is not more than 0.1.

An eleventh invention of the present invention is the image detecting device according to any of the first to the tenth inventions of the present invention wherein:

an angle formed by the direction of the optical axes of said optical fibers to said normal to the plane of incidence has a relationship of being smaller than an angle of reflection of lights emitted from said first illuminating means by said plane of incidence.

### BRIEF DESCRIPTION OF THE DRAWINGS

FIG. 1 shows a section of an unevenness detecting sensor in Embodiment A1 of the present invention;

FIG. 2 shows a top view of the unevenness detecting sensor in Embodiment A1 of the invention;

FIG. 3(a) through FIG. 3(e) illustrate a manufacturing process for a fiber-containing optical plate in Embodiment A1 of the invention;

FIG. 4(a) through FIG. 4(c) illustrate the interfacing state of glass and a fiber plate in each joining stage of direct joining in the manufacturing process of the fiber-containing optical plate in Embodiment A1 of the invention;

FIG. 5 shows a section which illustrates packaging of the unevenness detecting sensor in Embodiment A1 of the invention;

FIG. 6 shows a section of the packaged state of the unevenness detecting sensor in Embodiment A1 of the invention;

FIG. 7(a) illustrates the operating principle of the unevenness sensor in Embodiment A1 of the invention;

FIG. 7(b) illustrates the designing principle of the fiber-containing optical plate in Embodiment A1 of the invention;

FIG. 8 shows a section of an unevenness detecting sensor in Embodiment A2 of the invention;

FIG. 9 shows a section of an unevenness detecting sensor in Embodiment A3 of the invention;

FIG. 10 shows a section of an unevenness detecting sensor in Embodiment A3 of the invention;

FIG. 11 shows a section of an unevenness detecting sensor in Embodiment A4 of the invention;

FIG. 12 shows a section of an unevenness detecting sensor in Embodiment A4 of the invention;

FIG. 13 shows a section of an unevenness detecting sensor in Embodiment A4 of the invention;

FIG. 14 shows a section of an unevenness detecting sensor in Embodiment A4 of the invention;

FIG. 15 shows a section of an unevenness detecting sensor in Embodiment A5 of the invention;

FIG. 16 is a sectional structural diagram of an image detecting device in Embodiment B1 of the invention;

FIG. 17 is a diagram for describing the operation of the image detecting device in Embodiment B1 of the invention;

FIG. 18 is a diagram for describing the operation of the image detecting device in Embodiment B1 of the invention;

FIG. 19 is a diagram for describing the operation of the image detecting device in Embodiment B1 of the invention;

FIG. 20 is a diagram for describing the operation of an image detecting device in Embodiment B2 of the invention;

FIG. 21 is a diagram for describing the operation of an image detecting device in Embodiment B3 of the invention;

FIG. 22(a) through FIG. 22(b) are diagrams for describing the operation of an image detecting device in Embodiment B4 of the invention;

FIG. 23 shows a schematic configurational diagram of the unevenness pattern detecting device according to the prior art;

FIG. 24 shows an enlarged sectional view of the essential part of the unevenness pattern detecting device according to the prior art; and

FIG. 25 is a block diagram illustrating the schematic configuration of the image detecting device in this embodiment.

(Description of symbols)

| | |
|---|---|
| 1 | Fiber |
| 2 | Glass |
| 3 | Photoelectric converting device |
| 4 | Illuminating device |
| 5 | Bump |
| 6 | Adhesive |
| 7 | Outlet line |
| 8 | External electrode pad |
| 10 | Light absorber |
| 11 | Light reflector |
| 12a, 12b | Packages |
| 13 | External electrode |
| 14 | Lead wire |
| 15 | Case |
| 16 | Printed circuit board |
| 50 | Fiber-containing optical plate |
| 60 | Unevenness detecting sensor |
| F | Finger |
| 100 | Image detecting device |
| 101 | Optical fiber substrate |
| 102 | Optical fiber bundle |
| 103 | Base glass |
| 104 | First illuminating means |
| 105 | Second illuminating means |
| 106 | Image sensor |
| 107 | Plane of incidence |
| 108 | Plane of emission |
| 110 | Control circuit |
| 111 | Drive circuit |
| 703 | Absorbing layer |
| φ | Inclination angle of fiber |
| θa, θb | Angles at which lights reflected by an optical |
| | plate face (plane of incidence) are transmitted |
| | within fibers |
| θC | Angle at which incident lights are totally reflected |
| | by the plane of incidence |
| θS | Angle at which external lights are transmitted within |
| | fibers |

### BEST MODES FOR CARRYING OUT THE INVENTION

The embodiments of techniques related to the present invention to solve the aforementioned first problem and/or second problem will be described below with reference to drawings.

### EMBODIMENT A1

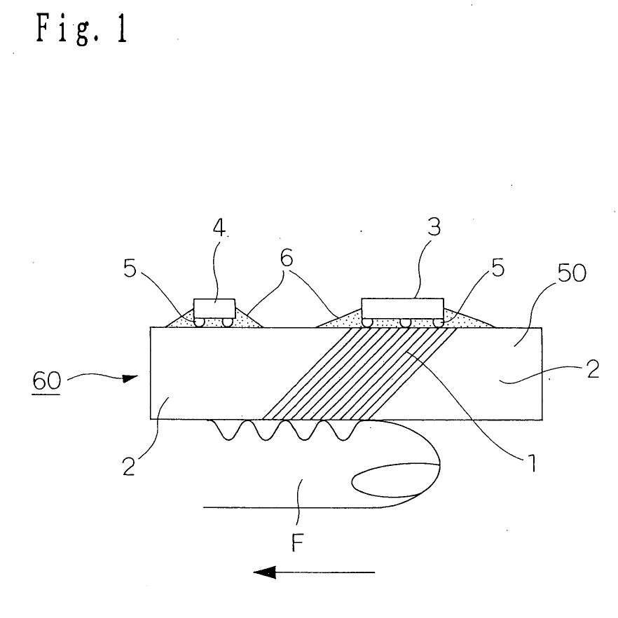

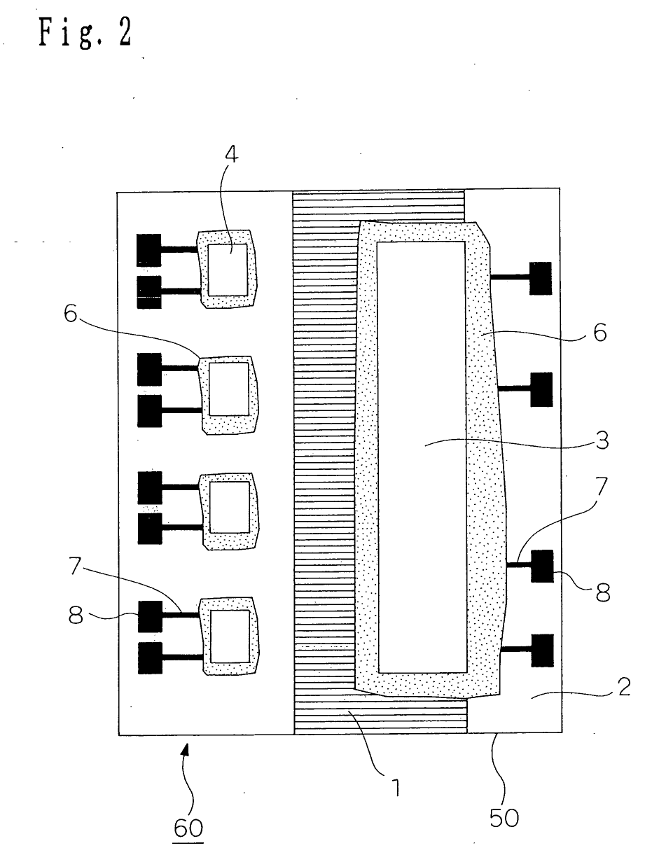

FIG. 1 and FIG. 2 respectively show a section and a top view of an unevenness detecting sensor in Embodiment A1 of techniques related to the invention.

An unevenness detecting sensor 60 consists of a fiber-containing optical plate 50 on one of whose surfaces an illuminating device 4 and a photoelectric converting device (image sensor) 3 are packaged. A finger F, which constitutes the object of detection, is placed in close contact with the plane of incidence of the fiber of the surface opposite the surface on which the illuminating device 4 and the photoelectric converting means 3 are packaged. By moving the finger F in the direction of the arrow in FIG. 1, a two-dimensional unevenness pattern can be obtained.

Constituent elements of this unevenness detecting sensor 60 will be described in detail below. The fiber-containing optical plate 50 is formed of a material in a planar shape and capable of transmitting lights radiated from the illuminating device, and fibers 1 are embedded in part of it. The optical axis of each fiber 1 is not vertical but inclined relative to the main surface of the optical plate.

The fibers 1, as shown in FIG. 1, are provided to span the full width of the finger F in the widthwise direction and as long as the width of the photoelectric converting device in the lengthwise direction. Each fiber consists of a core, a cladding and an absorber around the cladding. Glass is used for other parts than the fibers.

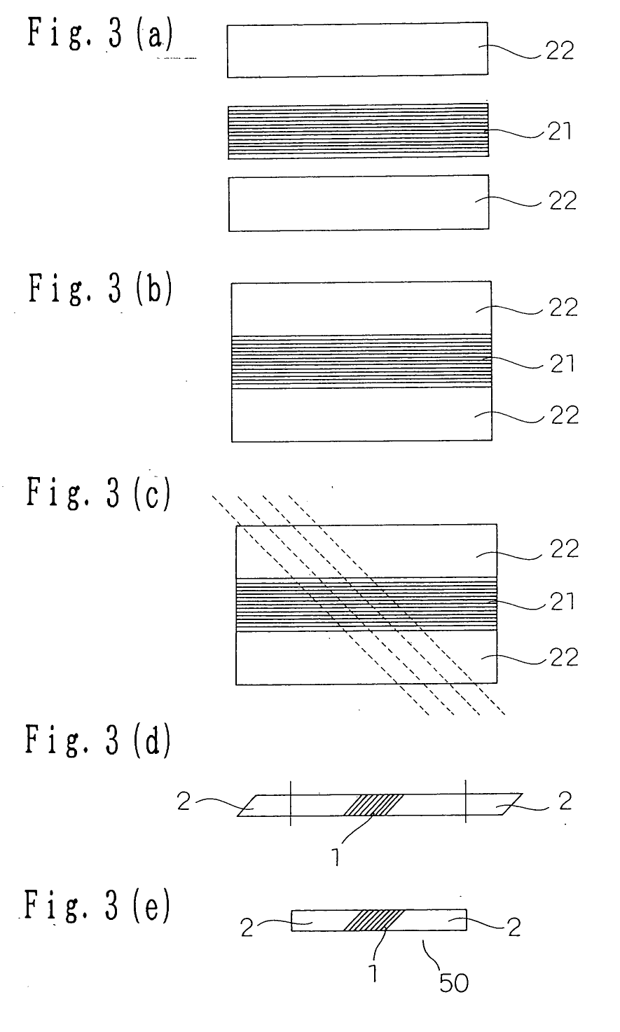

FIGS. 3 are process diagrams illustrating a manufacturing method of the fiber-containing optical plate. The two main faces each of two glass sheets 22 are optically polished. Similarly, the thickness of a fiber plate 21 is adjusted and its surface is optically polished (FIG. 3(a))

The fiber plate 21 is sandwiched between the glass sheets 22 and joined (FIG. 3(b)). At this step, the optical axes of the fibers are made parallel to the surfaces of the glass sheets 22. Available joining methods include a) heat sealing, b) adhesion and c) direct bonding and the like.

In heat sealing, the fiber plate, sandwiched between the glass sheets, is heated while under pressure. By using glass sheets lower in melting point than the fiber plate, the junction faces of the glass sheets are melted to be sealed with the fiber plate.

By this method, joining can be accomplished with comparative ease. On the other hand, it invites thermal distortion of the glass sheets, resulting in somewhat inferior shaping performance. For adhesion, an optical adhesive whose index of refraction becomes substantially equal to those of the glass sheets and the fiber plate after hardening is used.

Use of an ultraviolet-setting type adhesive would permit extremely easy adhesion without having to raise the temperature. Thick application of the adhesive or a large difference in the index of refraction would give rise to scattering and absorption, inviting an increase in stray lights.

Direct bonding is a method by which joining is carried out by bringing surface-treated junction faces into contact with each other; as it involves no intervention of an intermediate layer, such as the adhesive, and joining can be accomplished by heat treatment at low temperature, it has an advantage of being free from reflection or scattering by the junction faces and allowing retention of the shape.

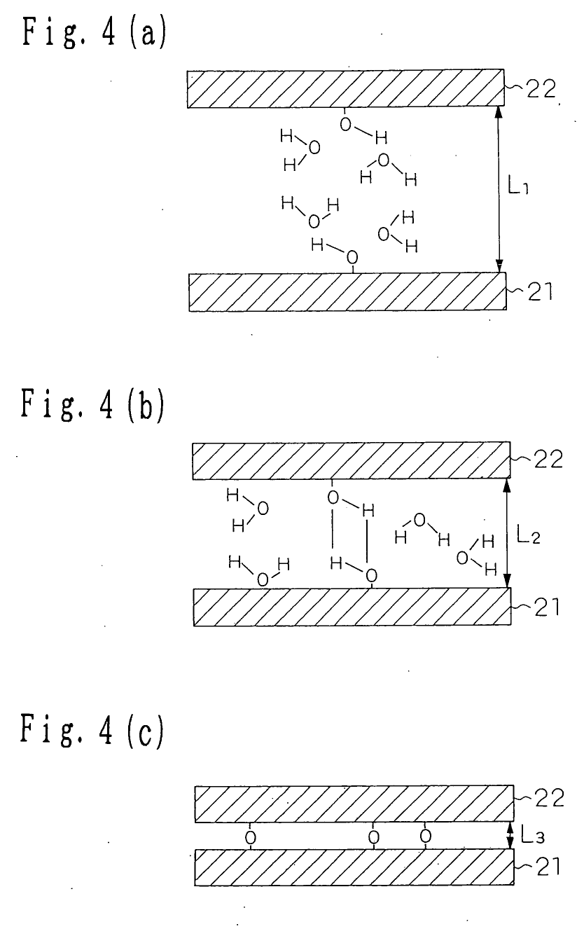

The principle of direct bonding will be described below with reference to FIGS. 4. FIGS. 4 show the interface states of a glass sheet and a fiber plate at different stages of joining by direct bonding.

To carry out joining by direct bonding, the surface of each substrate is polished to make a uniform mirror surface, then cleaned, and cleared of dust and contaminants on it. This substrate is subjected to hydrophilic treatment to activate its surface and, after drying, two substrates are laid one over the other.

In FIG. 4(a) through FIG. 4(c), L1, L2 and L3 represent distances between the substrates.

First, both faces of the glass sheet 22 and the fiber plate 21, which are the substrates, are mirror-ground. Then, these glass sheet 22 and fiber plate 21 are washed in a mixture of ammonia, hydrogen peroxide and water (ammonia water:hydrogen peroxide:water=1:1:6 (in volume ratio)), and the glass sheet 22 and the fiber plate 21 are subjected to hydrophilic treatment. As shown in FIG. 4(a), the surfaces of the glass sheet 22 and the fiber plate 21 washed with the liquid mixture is terminated with hydroxyl groups (—OH groups) and has become hydrophilic (the state before bonding).

Next, as shown in FIG. 4(b), piezoelectric substrates of the glass sheet 22 and the fiber plate 21 having undergone hydrophilic treatment are joined so that the direction of their polarization axes be in the reverse direction to each other (L1>L2).

This gives rise to dehydration, and the piezoelectric substrate 2 and the piezoelectric substrate 3 are caused to attract each other by the attracting force of the polymerization of hydroxyl groups or hydrogen bonding or the like and thereby joined together.

Joining opposite faces without the intervention of a bonding layer of an adhesive or the like on the interface by subjecting the mirror-ground faces to surface treatment and bringing into contact with each other as described above is known as joining by “direct bonding”.

Since joining by direct bonding uses no adhesive, no bonding layer is present on the joining interface. Further, in general, heat treatment at low temperature makes it stronger joining at the atomic level, such as covalent bonding or ionic bonding, by comparing with the joining by intermolecular force.

Also, if so desired, the glass sheet 22 and the fiber plate 21 joined together in the above-described way may be subjected to heat treatment at a temperature of 450° C.

This would place the atoms constituting the glass sheet 22 and those constituting the fiber plate 21 in a state of covalent bonding via oxygen atoms O (L2>L3) as shown in FIG. 4(c), resulting in even firmer direct bonding of the two substrates at the atomic level.

Thus, there is achieved a bonded state in which no bonding layer, such as one of adhesive, is present on the joining interface.

In another case, the gap between the atoms constituting the glass sheet 22 and those constituting the fiber plate 21 are in a state of covalent bonding via hydroxyl groups, in which the two substrates are in firm direct bonding at the atomic level.

To add, if the substrates are readily affected by heat, no heat treatment is needed. Further, where heat treatment is to be performed, it is desirable to carry out heat treatment at or below a temperature where the fiber will not vary in characteristics and will not melt. This can result in even firmer direct bonding.

The bonded glass sheet and the fiber plate are cut into a planar shape. The cutting is done at an angle to the bonding face as shown in FIG. 3(c).

The cutting was done using a wire saw. The cutting intervals were 1.1 mm. The angle of cutting will be discussed afterwards. The cut-out plate is shaped into a rectangle by cutting the edges (FIG. 3(d)).

By optically polishing the two main faces of this plate, the fiber-containing optical plate 50 can be fabricated. It is a rectangle of 20 mm×10 mm, measuring 1.0 mm in thickness after the polishing (FIG. 3(e))

An illuminating device and a photoelectric converting device are packaged over the fiber-containing optical plate fabricated as described above.

As shown in FIG. 2, outlet lines 7 were formed on the illuminating device and the photoelectric converting device for power supply, grounding, signal extraction and so forth. At the tip of each outlet line 7 was also formed an external electrode pad 8 to let signals be taken outside. The outlet lines 7 and the external electrode pads 8 are patterned out of a metal film of gold, aluminum or the like by masked vapor deposition.

Over the outlet lines opposite the electrodes of the illuminating device 4 and the photoelectric converting device 3 are driven metal bumps 5. The electrodes of the illuminating device 4 and the photoelectric converting device 3 are connected to the outlet lines 7 on the fiber-containing optical plate via these metal bumps 5, so that signals can be exchanged via the external electrode pads.

For the illuminating device, a red LED was used as a bare chip. For the photoelectric converting device, a silicon photodiode array was similarly used, also as a bare chip. The gap between the optical plate and the chip surface was filled with an adhesive having an index of refraction close to the index of refraction of the glass sheet or the fibers for a reason to be explained afterwards.

In the silicon photodiode array of the photoelectric converting device, photodiodes are two-dimensionally arranged at a pitch of 50 μm. In the direction of the channel, which corresponds to the widthwise direction of the finger, 300 photodiode elements are arranged, and 16 lines of these 300 elements each are arranged in the longitudinal direction, with the whole width of the finger being positioned over the photodiodes.

Signals in each element may be sequentially read out from the 1st through 300th channels of the first line, then the channels of the second line in a prescribed period of time. The signals that have been read out are digitized by an A/D converter (not shown), and processed by a CPU into a picture.

The fiber-containing optical plate being 1 mm in thickness, an extremely thin unevenness detecting sensor was successfully fabricated for packaging bare chip LEDs and a silicon photodiode array.

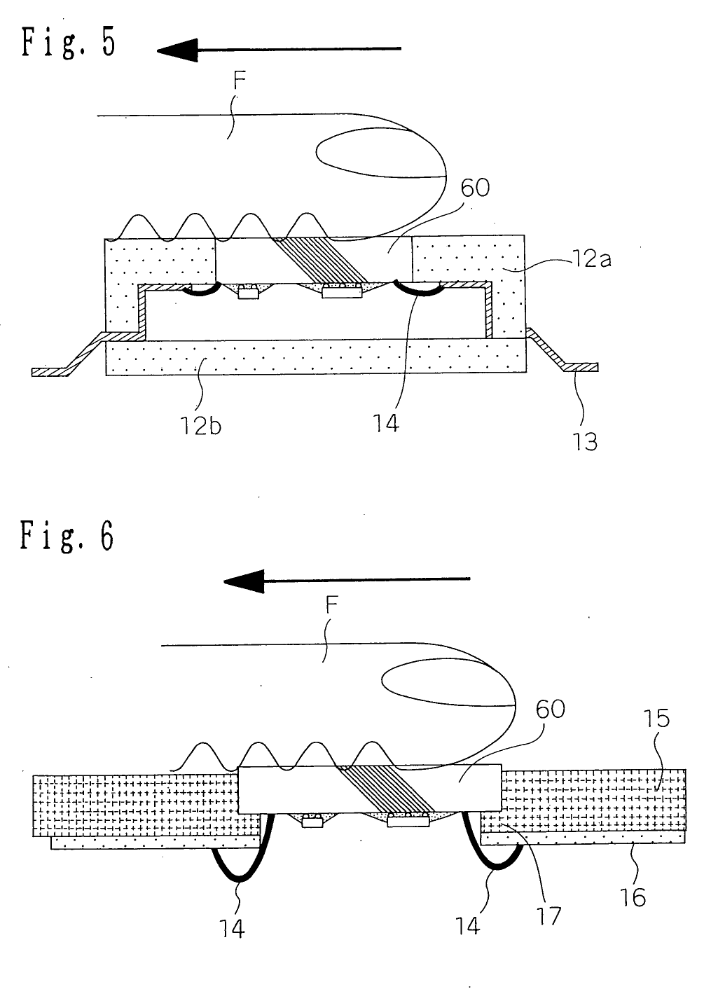

FIG. 5 shows a sectional view of an example of packaging of the unevenness detecting sensor. The fiber-containing optical plate is fitted to a plastic-made package 12a, with its face mounted with the illuminating device and the photoelectric converting means directed inwards.

Inside the package 12a is a terminal connected to an external electrode 13, and a lead wire connects the external electrode pad of the fiber-containing optical plate and this terminal to allow signals to be taken out of the package. Underneath the package 12a is sealed down another package 12b. As hitherto described, the unevenness detecting sensor was accommodated into the surface-mountable package.

FIG. 6 shows a sectional view of another example of packaging. This is an example in which the unevenness detecting sensor is directly packaged into the case of an apparatus which is to be equipped with the unevenness detecting sensor.

An opening is bored in part of a case 15, and the unevenness detecting sensor is fitted into this opening. Within the opening in the case are provided convexes, and the fiber-containing optical plate is snapped onto them. Within the case is fitted a printed circuit board 16, and the external electrode pad of the unevenness detecting sensor and the printed circuit board are connected by lead wires 14.

As the unevenness detecting sensor is planarly shaped and is an integrated structure on which the illuminating device and the photoelectric converting means are packaged, it can be easily fitted to the case.

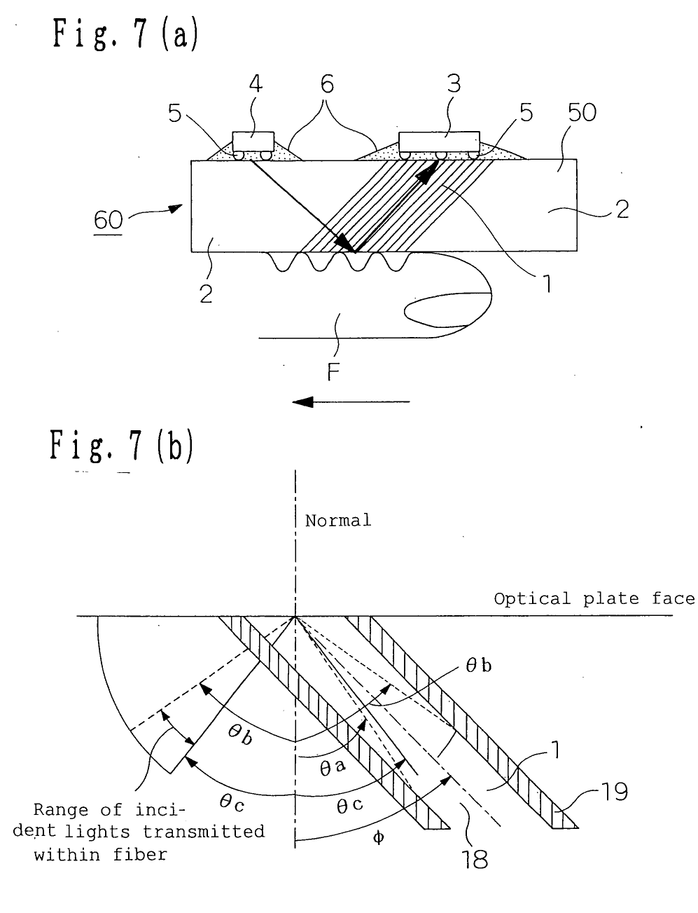

The operating principle of the unevenness detecting sensor in this example will be described with reference to FIGS. 7(a) and 7(b).

Lights are radiated from an LED, which is the illuminating device. The lights from the LED, dependent on their LED-directionality, are radiated dispersively in the optical plate. Here, so that the lights may not be reflected by the surface of the optical plate, the gap between the surface of the LED and that of the optical plate was filled with a resin whose index of refraction was close to that of the glass sheets of the optical plate to prevent any air layer from being formed in that gap.

The LED i's mounted in such a position that, out of the lights radiated from the surface of the LED, those directly reaching the plane of incidence of the fiber be totally reflected by the plane of incidence of the fiber. If there is no convex object in contact with the plane of incidence but there is an air layer, the lights will be totally reflected as they are, propagate within the fiber, reach the surface of the photoelectric converting device and be converted into electrical signals.

If there is any convex object in close contact with the plane of incidence, as the relationship between the indices of refraction of the outside and the inside of the fiber will be disrupted, no total reflection by the plane of incidence of the fiber will occur. Therefore, as the intensity of lights propagating within the fiber and reaching the photoelectric converting device differs with the presence or absence of unevenness in close contact, it was possible to detect the unevenness pattern as a picture (FIG. 7(a)).

The critical angle of total reflection θc at which the lights having propagated within the optical plate are totally reflected by the plane of incidence of the fiber is θc=sin⁻¹ (1/n core), where the index of refraction of the core of the fiber is n core. Therefore, disposition to make the angle formed by the normal to the plane of incidence of the fiber and the light radiating face of the LED not less than θc would give rise to total reflection by the fiber surface.

More preferably, the angle formed by the line linking the end of the fiber towards the LED side and the end of the light radiating face of the LED towards the fiber and the normal to the plane of incidence of the fiber should be no less than θs.

The angle φ the optical axis of the fiber forms relative to the normal to the plane of incidence of the fiber was so determined that more of the totally reflected lights from the plane of incidence of the fiber could be totally reflected between the core and the cladding in the fiber and be transmitted within the fiber.

FIG. 7(b) shows the relationship between the angle of reflection and the inclination angle of the fiber. As stated earlier, the critical angle of total reflection by the plane of incidence of the fiber is θc, and lights having a greater angle than this are totally reflected by the plane of incidence of the fiber. On the other hand, when the optical axis of the fiber is inclined by the angle φ relative to the plane of incidence, the range of the lights reflected by the plane of incidence that are totally reflected between the core and the cladding in the fiber and that are transmitted within the fiber comprises lights coming in between an angle θa and an angle θb relative to the normal to the plane of incidence, where θa and φ are represented by (Formula 2), and θb and φ, by (Formula 3).

φ=θa+cos⁻¹(n clad/n core) (Formula 2)

φ=θb−cos⁻¹ (n clad/n core) (Formula 3)

Therefore, the totally reflected lights within the range of (Formula 4) are transmitted within the fiber.

φ−cos⁻¹(n clad/n core)<θφ+cos⁻¹(n clad/n core) (Formula 4)

From FIG. 7(b), it is seen that, in order for more of totally reflected lights to be transmitted within the fiber, θa should be equal to or greater than θc. Therefore, the inclining angle φ of the optical axis of the fiber relative to the normal to the plane of incidence of the fiber can be determined to satisfy (Formula 5).

φ≧sin⁻¹(1/n core)+cos⁻¹(n clad/n core) (Formula 5)

By inclining the fiber at this angle, a picture of an unevenness pattern highest in the efficiency of utilizing incident lights and with a high contrast between concaves and convexes was successfully obtained. The output face for outputting from the fiber towards the photoelectric converting device is also inclined relative to the optical axis of the fiber.

The lights transmitted within the fiber will reach the output face at an angle for total reflection. If any substance whose index of refraction is smaller than that of the core of the fiber with a large difference in that respect, such as air layer, is in contact with the output face, the lights having transmitted within the fiber will not be outputted from, but will be totally reflected by, the output face and accordingly will not be inputted to the photoelectric converting device.

For this reason, the gap between the surface of the photodiode array of the photoelectric converting device and the output face of the fiber was filled with a resin whose index of refraction was not less than that of the core of the fiber. As a result, it was made possible for the output lights not to be totally reflected by the output face of the fiber but to be brought to incidence on the photodiode array of the photoelectric converting device.

In this embodiment, the adhesive used in packaging the photoelectric converting device by the bump method successfully performed this function. To add, while it is most preferable to use a resin having a higher index of refraction than that of the core, even if it is less than the index of refraction of the core, if it is close to that, outputting from the fiber is possible at a lower rate of total reflection.

Though the photoelectric converting device used in this embodiment covers the full width of the finger in 300 channels in the channel direction, there are only 16 lines in the direction of moving the finger. In this respect, a two-dimensional picture was successfully reconstructed by the CPU after repeatedly acquiring signals in the line direction.

Incidentally, although a photodiode array is used as the photoelectric converting device, a CCD or the like can be used as well.

To add, though glass is used as the material of the optical plate, a transparent resin such as acryl can as well be used, and the fiber may be a plastic one instead.

As hitherto described, a planar-shaped, thin and small-size unevenness detecting sensor in which an illuminating device and photoelectric converting means were integrated was successfully realized.

### EMBODIMENT A2

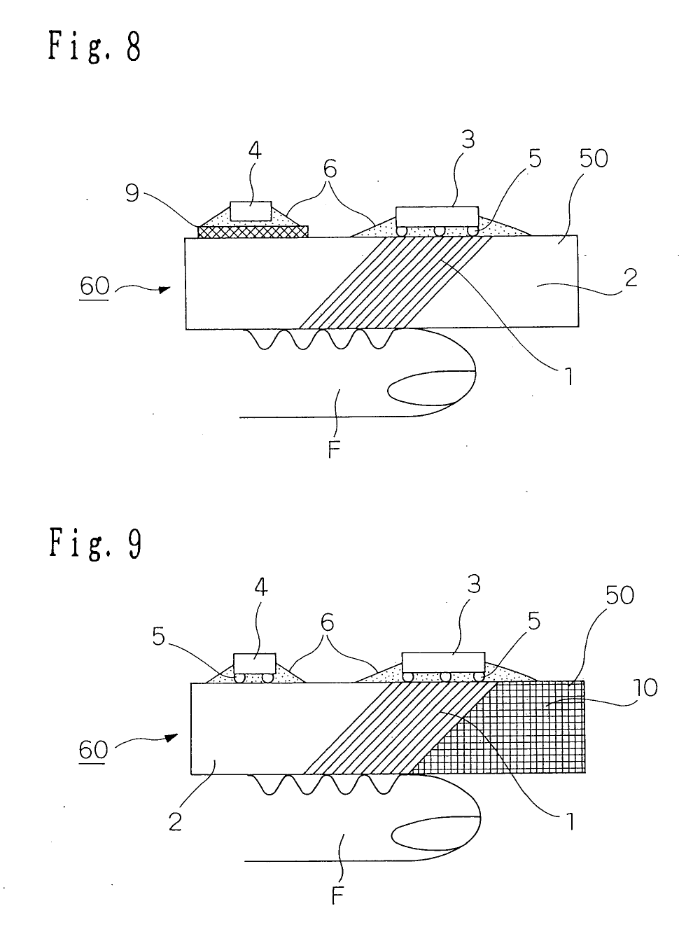

A section of an unevenness detecting sensor in Embodiment A2 of techniques related to the present invention is shown in FIG. 8. Packaging of the fiber-containing optical plate and the photoelectric converting device is the same as in Embodiment A1, and therefore its description will be dispensed with.

An optical guide plate 9 is provided between the illuminating device 4 and a glass sheet 2. Wiring to establish connection to the illuminating device was formed over the optical guide plate, bumps were driven on this wiring, and the illuminating device was packaged with an adhesive in-between. Lights radiated from the illuminating device are diffused substantially uniformly by the optical guide plate, and enter into the glass sheet.

As stated in describing Embodiment A1, though it is difficult for lights to come incident from the illuminating device directly on the glass sheet, the intervening optical guide plate has facilitated incidence While an adhesive is limited in the choice of materials and involves the problem of possible unevenness in adhesion, the use of the optical guide plate has facilitated more uniform incidence.

### EMBODIMENT A3

A section of a fiber-containing optical plate and an unevenness detecting sensor in Embodiment A3 of techniques related to the present invention is shown in FIG. 9.

In this embodiment, a fiber-containing optical plate partly having a light absorber 10 in a block form is used. The light absorber was molded of a glass material after mixing an absorber with it and melting the mixture. The configuration of an unevenness detecting sensor 60 herein is substantially the same as in Embodiment A1, and its detailed description will be dispensed with.

Part of the lights reaching the plane of incidence of the fiber from the illuminating device and totally reflected thereby are totally reflected within the fiber, not transmitted but pierce the fiber. Such lights may be reflected by an end face of a glass sheet 2 or the like to directly enter into the photoelectric conversion element or return into the fiber and detected by the photoelectric converting device.

The presence of such stray lights would allow lights even from parts with which the convexes of the object are in close contact to prevent lights from those parts from reaching the photoelectric converting device to be outputted from the photoelectric converting device. This would make the unevenness pattern less contrasty or reduce the resolution.

By embedding the light absorber 10 into the optical plate on the reverse side to the illuminating device 4, lights crossing and piercing the fiber and scattered are absorbed. This serves to dramatically reduce stray lights, enabling a highly contrasty unevenness pattern to be obtained.

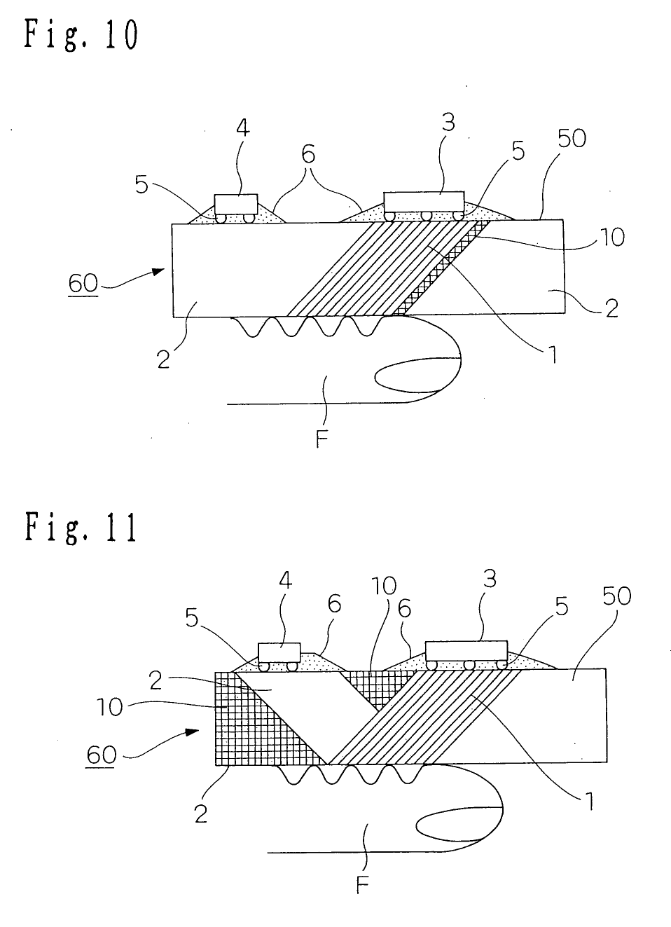

FIG. 10 is a section showing another embodiment using a light absorber. As shown in FIG. 10, the light absorber was provided as a filmy resin on the interface between a fiber 1 and a glass sheet 2.

Bonding the fiber 1 and the glass sheet 2 was accomplished by joining them with a light absorbing adhesive. By merely choosing an adhesive in the manufacturing process, production can be achieved easily without having to make ready a block-shaped absorber.

It is also acceptable to join the fiber and the glass sheet by sandwiching planar light absorbers between them.

To add, the usable materials for the light absorber may include, besides glass, metals including such as alumite-processed aluminum, ceramic and carbon plates.

### EMBODIMENT A4

A section of an unevenness detecting sensor using a fiber-containing optical fiber in Embodiment A4 of techniques related to the present invention is shown in FIG. 11. The configuration of an unevenness detecting sensor 60 herein is substantially the same as in Embodiment A1, and its detailed description will be dispensed with.

The fiber-containing optical fiber is provided with block-shaped light absorbers in two positions on the illuminating device 4 side. As the light absorbers 10, what were melt-molded by incorporating absorbent material into glass were used. The light absorbers 10 were so arranged that they could absorb, out of the lights radiated from the illuminating device 4, other lights than those totally reflected by the plane of incidence of the fiber 1.

Thus, with the width of the plane of incidence of the fiber in-between, the light absorbers 10 were arranged on the two sides of the path of lights radiated from the illuminating device 4 at greater angles than the critical angle of total reflection. From the illuminating device 4, depending on its directionality, lights are radiated in substantially all the directions within the optical plate. By providing the light absorbers 10 on the incident side and having them absorb and remove those incident lights which are not totally reflected, prevention of all but totally reflected lights from entering into the photoelectric conversion element was successfully achieved.

This reduced the scattering of lights radiated from the illuminating device by the glass sheet face or the fiber face and the inputting of resultant stray lights into the photoelectric converting device, making it possible to realize an unevenness detecting sensor excelling in contrast.

It also made possible achievement of a higher efficiency of light utilization than where an absorber is used and to reduce the luminance of the illuminating device, thereby contributing to reduce the voltage and the power consumption.

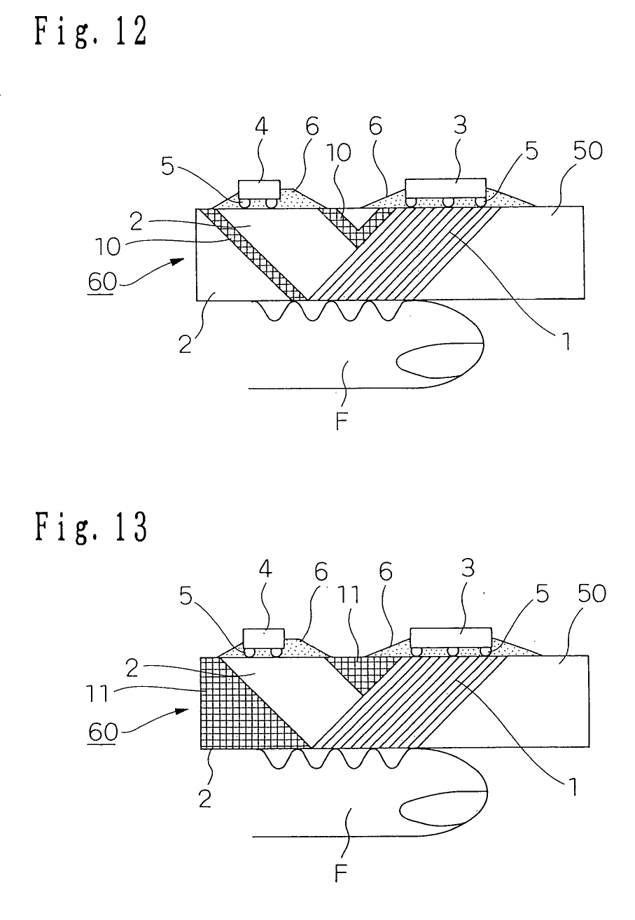

FIG. 12 shows a section in another embodiment in which the light absorbers 10 are used.

As shown in FIG. 12, the light absorbers were provided as filmy resin within the glass sheet 2. They were formed by molding the glass sheet 2 in three separate parts and, when bonding them, joining them with a light-absorbing adhesive to form them. By merely choosing an adhesive in the manufacturing process, production can be achieved easily without having to make ready a block-shaped absorber.

It is also acceptable to join the fiber and the glass sheet by sandwiching planar light absorbers 10 between them.

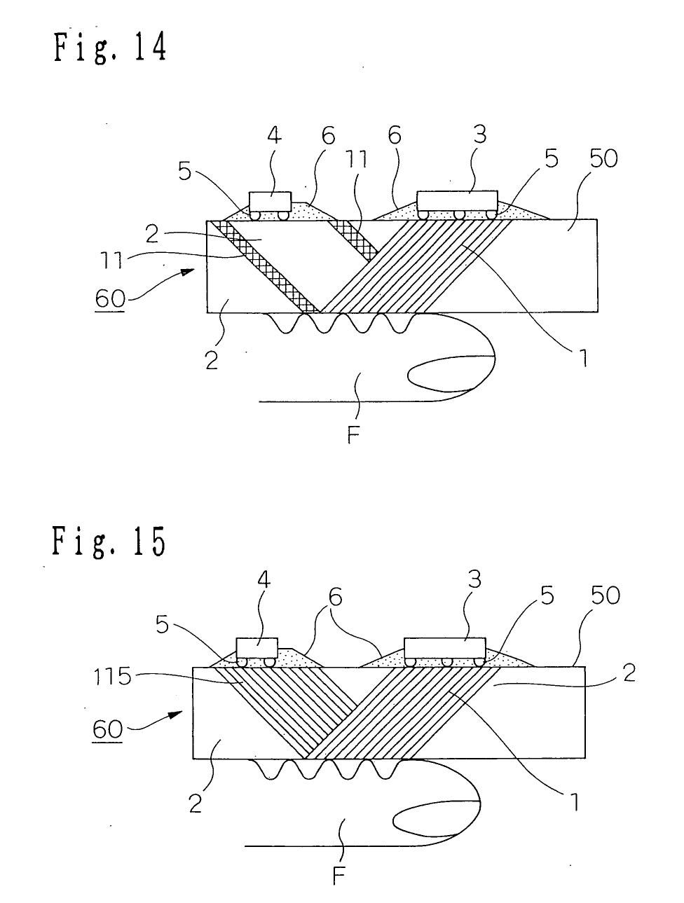

To add, it is also possible to use, in addition to the light absorbers 10 made of such as glass materials, light reflectors 11 made of metal such as alumite-processed aluminum, ceramic or carbon plates (FIGS. 13 and 14).

### EMBODIMENT A5

A section of an unevenness detecting sensor using a fiber-containing optical plate in Embodiment A5 of techniques related to the present invention is shown in FIG. 15. The configuration of an unevenness detecting sensor 60 herein is substantially the same as in Embodiment A1, and its detailed description will be dispensed with.

The fiber-containing optical plate 50, as the same in other embodiments, has the fibers 1 each having an optical axis inclined relative to the plane of incidence, and other fibers 115 embedded there in inclined in reverse direction (see FIG. 15).

Over the plane of incidence of these fibers 115 is packaged the illuminating device 4. The output end of each fiber 115 is joined to a side of the fiber 1. As the fiber 115 is installed at an angle greater than the critical angle of total reflection relative to the plane of incidence of the fiber 1, lights radiated from the illuminating device 4 are not scattered elsewhere but are totally reflected by the plane of incidence of the fiber 1.

Since the disposition described above prevents incident lights from being scattered and becoming stray lights, a highly contrasty unevenness detecting sensor excelling in resolution was successfully realized.

As is evident from the foregoing description, the present invention can provide a fiber-containing optical plate which is planar and accordingly thin and permits lights totally reflected by the main face of the plate to be propagated to the plane of emission of the fiber.

Further according to this example, it is possible to provide a planar, thin and small-sized unevenness detecting sensor over whose main face is packaged an illuminating device and a photoelectric converting device Furthermore, a highly contrasty unevenness detecting sensor relatively free from stray lights and excelling in resolution can be realized.

Next will be described embodiments of the present invention to solve the third problem stated above with reference to drawings.

### EMBODIMENT B1

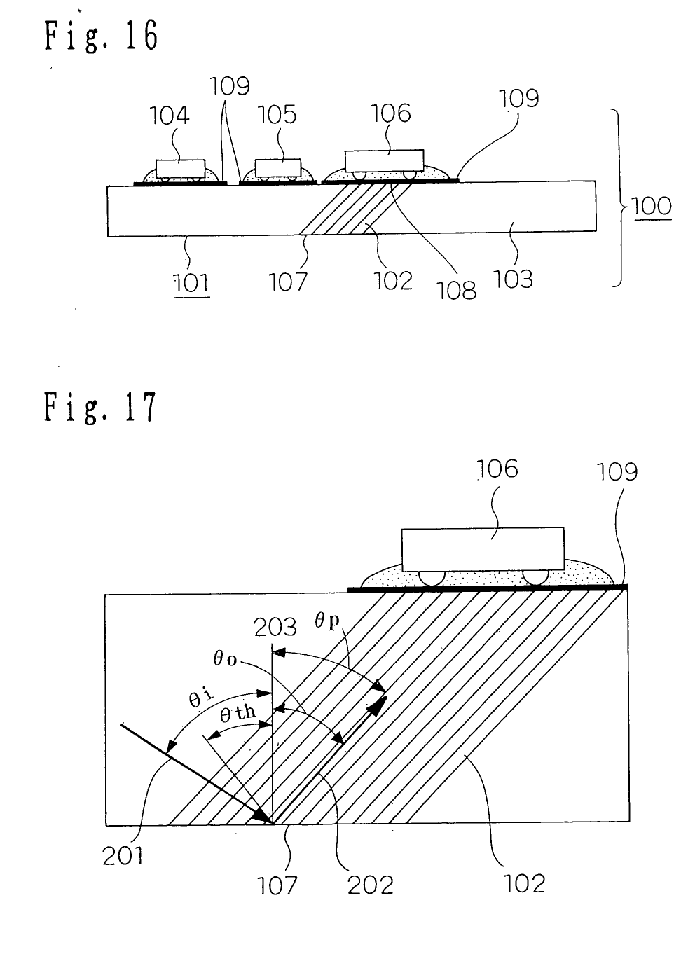

An image detecting device in one embodiment of the present invention will be described with reference to FIG. 16 through FIG. 18 and FIG. 25.

FIG. 16 is a sectional structural diagram of an image detecting device in Embodiment B1 of the invention. In the drawing, an image sensor 106, first illuminating means (e.g. an LED) 104 and second illuminating means (e.g. an LED) 105.

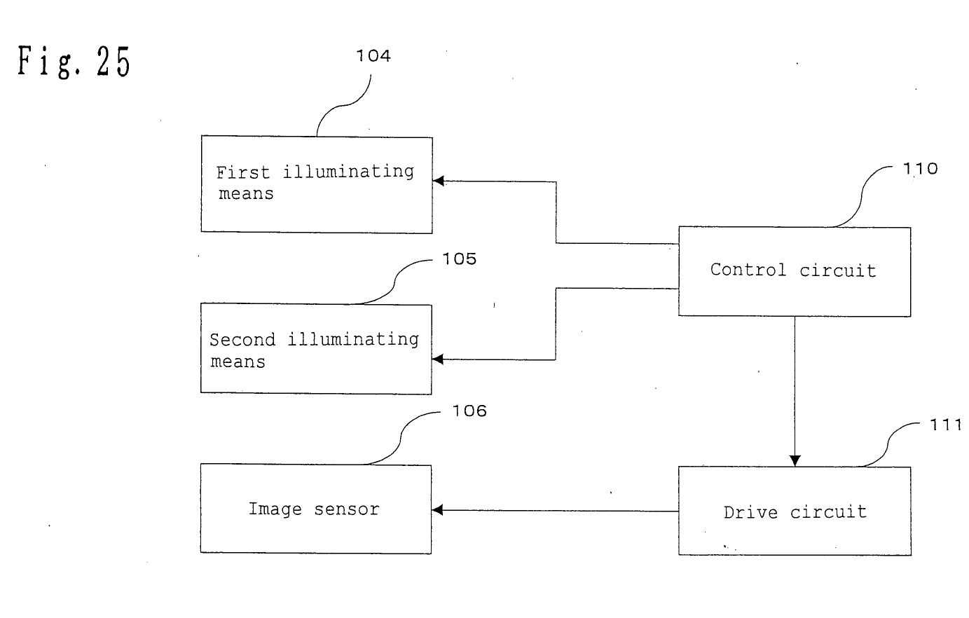

It is further provided with a control circuit 110 and a drive circuit 111 to perform control for selectively turning on either the first illuminating means 104 or the second illuminating means 105 (see FIG. 25). FIG. 25 is a block diagram illustrating the schematic configuration of the image detecting device in this embodiment.

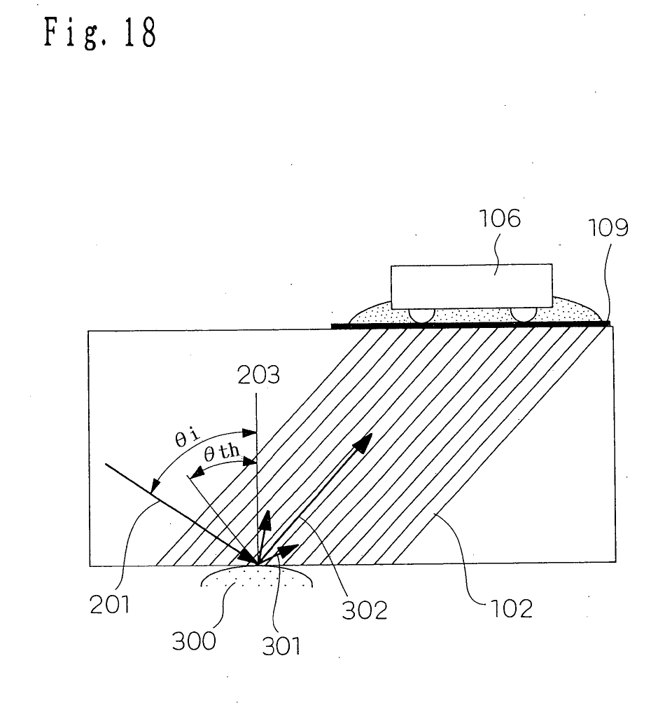

FIG. 17 and FIG. 18 shows enlarged sections of the surroundings of the plane of incidence in FIG. 16. Incident lights 201 are lights irradiating the plane of incidence from the first illuminating means. Reflected lights 202 are lights resulting from the reflection of the incident lights 201 by a plane of incidence 107. An angle θi is formed between the incident lights 201 and the normal to the plane of incidence, and θth is the critical angle of total reflection of optical fibers 102 on the plane of incidence 107 relative to air.

As further shown in FIG. 18, out of scattered lights 301 scattered by the convexes 300 of the object, lights which form an angle to the optical axis of the optical fiber not greater than the critical angle of total reflection inside the optical fiber are denoted by 302.

The optical fiber substrate 101 is configured by causing a plurality of optical fibers 102 to penetrate a base glass 103 in its thickness direction and embedding it therein.

The plane of incidence 107 and the plane of emission 108 are formed in the exposed areas at the ends of the optical fibers 102. A circuit conductor layer 109 is formed over the face of the optical fiber substrate on the side where the plane of emission is formed, and an image sensor 106 is packaged face down in a prescribed position matching the position of emission via optically transmissive insulating resin.

The direction of this optical axis of each optical fiber is configured at a prescribed angle to the direction of the normal to a first main face of the optical fiber substrate constituting the plane of emission.

Further the first and second illuminating means 104 and 105 are arranged face down in prescribed positions over the optical fiber substrate via optically transmissive insulating resin.

For instance, as shown in FIG. 17, this first illuminating means 104 is so arranged that the angle of incidence (θi) of its illuminating lights formed with the normal 203 to the plane of incidence of the optical fiber be greater than the critical angle of total reflection (θth) and the direction of reflection of the illuminating lights from the first illuminating means 104 by the plane of incidence be within the critical angle of total reflection (θfa) within the optical fiber relative to the direction of the optical axis of the optical fiber.

Thus, the angle formed by the direction (θp) of the main axis of the optical fiber embedded in the substrate of the optical fiber and the direction (θo) of the reflection of the illuminating lights from the first illuminating means 104 by the plane of incidence is set to be smaller than the critical angle of total reflection θfa within the optical fiber.

More specifically, the position of the first illuminating means 104 relative to the plane of incidence and the inclining angle of the optical fiber are so determined that a relationship of θo−θfa<θp<θo+θfa hold.

Here the critical angle θfa of total reflection inside the optical fiber is the largest angle at which lights can propagate within the optical fiber without loss, and can be represented by cos (θfa)=(n2/n1) where n1 is the index of refraction of the core material and n2, the index of refraction of the cladding of the optical fiber.

The second illuminating means 105 is so arranged that the angle of incidence of its illuminating lights relative to the plane of incidence of the optical fiber be smaller than the critical angle and the direction of the reflection of the illuminating lights by the plane of incidence be within the critical angle of total reflection within the optical fiber relative to the direction of the optical axis of the optical fiber.

Next will be described the operation of the image detecting device in this embodiment.

First, where unevenness on a relatively soft object, such as a rubber stamp or a fingerprint, in optically close contact with the plane of incidence of the optical fiber substrate is to be detected, the first illuminating means is used to irradiate the plane of incidence, which is one end, of the optical fiber with the illuminating lights.

In the concaves, where the condition for total reflection by the optical fiber relative to air is satisfied, the incident lights 201 are fully reflected by the plane of incidence 107. The reflected lights 202 are embedded in the optical fiber substrate 101 with an inclination in the thickness direction.

Thus, as the angle formed by the direction of the main axis of the optical fiber embedded in the optical fiber substrate and the direction (θo) of lights reflected by the plane of incidence is set to be smaller than the critical angle of total reflection (θfa) within the optical fiber, and therefore that inclined optical axis of the optical fiber and the reflected lights 202 satisfy the condition for total reflection within the optical fiber, the lights are transmitted to the image sensor 106 without being absorbed to output a voltage matching the luminous energy.

Arrangement to enable the angle of the optical fiber for even those lights, out of the lights radiated from the first illuminating means to the plane of incidence, which is one end, of the optical fiber and satisfying the condition for total reflection by the optical fiber relative to air, deviating by the angle of propagation by the optical fiber to satisfy the aforementioned condition makes possible efficient propagation.

For this reason, a satisfactory light flux is propagated to the plane of emission and outputted from the image sensor 106 as a voltage.

On the other hand, since the convexes 300 of the object do not satisfy the condition for total reflection by the plane of incidence, the incident lights 201 are emitted outside the optical fiber substrate from the plane of incidence 107 and scattered on the surface of or within the convexes 300 of the object, and part of them are again brought to incidence into the optical fiber substrate as the reflected lights 301 from the plane of incidence.

The lights 302, which constitute another part of the reflected lights 301 and of which the direction of transmission relative to the optical axis of the optical fiber are not greater than the critical angle of total reflection inside the optical fiber, repeat total reflection within the optical fiber, and are transmitted from the plane of emission to the image sensor 106, thereby a voltage matching their luminous energy is output.

Then, when optical picture information on an object which is a printed matter or the like is to be read by bringing it into contact with the plane of incidence of the optical fiber substrate, the second illuminating means is used to irradiate the plane of incidence, which is one end, of the optical fiber with illuminating lights.

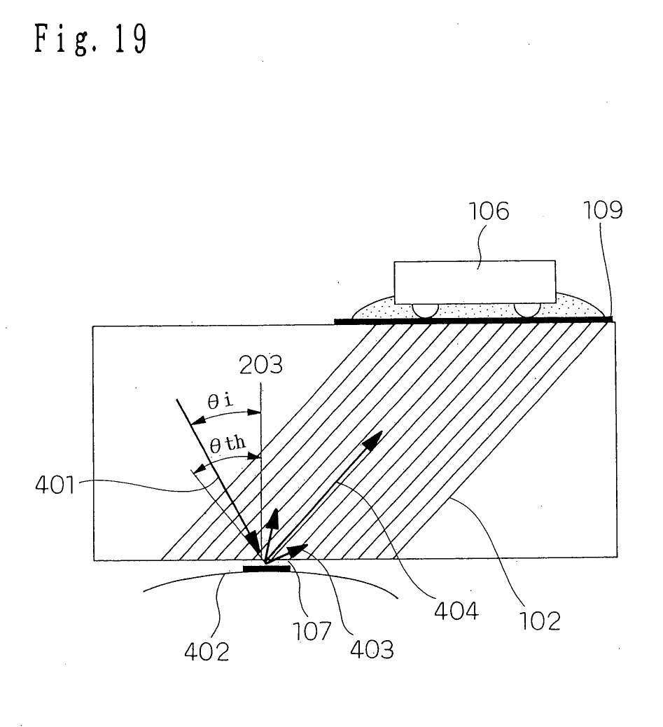

Since incident lights 401 are brought to incidence at an angle smaller than the critical angle θth of the optical fiber as shown in FIG. 19, they are little reflected by the plane of incidence, and most of their luminous energy irradiates an object copy face 402. The object copy face reflects scattered lights according to its gradation, and part of them are again brought to incidence into the optical fiber substrate from the plane of incidence as reflected lights 403.

Lights 404 contained in the reflected lights 403, i.e. the lights 404 of which the direction of transmission relative to the optical axis of the optical fiber are not greater than the critical angle of total reflection inside the optical fiber, repeat total reflection within the optical fiber, and are transmitted from the plane of emission to the image sensor 106, thereby a voltage matching their luminous energy is output.

The direction (θp) of the optical axis of the optical fiber and the direction (θo) of the illuminating lights from the first illuminating means reflected by the plane of incidence are off each other by the critical angle of total reflection θfa inside the optical fiber.

For this reason, out of the illuminating lights from the second illuminating means scattered by the object copy face 402, those lights matching this angle of deviation enter into the optical fiber from the plane of emission. Then, as the lights having entered inside are within the critical angle of total reflection inside the optical fiber, they propagate within the optical fiber without loss, and are transmitted from the plane of emission to the image sensor 106. This causes a voltage matching their luminous energy to be outputted.

Further, by determining the position of the first illuminating means 104 relative to the plane of incidence and the inclining angle of the optical fiber so as to establish a relationship in which the angle θp formed by the direction (θp) of the optical axis of the optical fiber and the normal 203 to the plane of incidence is smaller than the angle of reflection θo of lights emitted from the first illuminating means 104 by the plane of incidence (θo−θfa<θp<θo), the optical fiber can be arranged at an angle where the luminous energy of scattered lights entering from the plane of emission into the propagation angle of the optical fiber, a large output voltage can be obtained from the image sensor.

The control circuit can be so configured as to allow the user of the device to choose here between turning on the first illuminating means and turning on the second illuminating means according to the type of the object.

Or in some cases, it is also possible to consecutively acquire unevenness information and picture information substantially at the same time by repeatedly turning on and off the first illuminating means and the second illuminating means at high speed at an instruction from the control circuit and driving, interlocked with this instruction, the image sensor with the drive circuit.

The first illuminating means here is required to irradiate the plane of incidence at an angle greater than the critical angle of the optical fiber. This means that the first illuminating means must be arranged in a position in an area away from it by d×tan (θth) or more from and opposite the plane of incidence of the optical fiber array substrate in the thickness direction, where d is the thickness of the optical fiber substrate and θth, the critical angle of the optical fiber.

Also, the second illuminating means needs to irradiate the plane of incidence only with lights having angle smaller than the critical angle of the optical fiber.

### EMBODIMENT B2

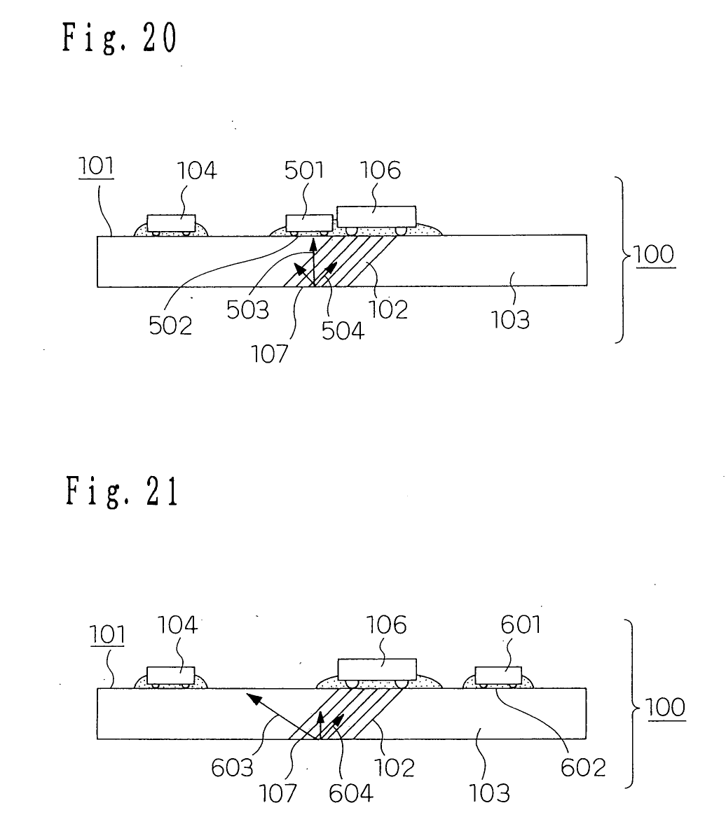

FIG. 20 is a sectional structural diagram of an image detecting device in Embodiment B2 of the invention.

Second illuminating means 501 is the main face constituting the plane of emission of the optical fiber substrate, and is arranged in an area 502 opposite the plane of incidence. Lights emitted from the second illuminating means are brought to incidence on the plane of incidence substantially normally. Lights reflected by the object are powerfully emitted in a normal direction 503 where the Snell laws of refraction hold. Though these reflected lights are lights reflected from the object copy surface but not dependent on picture information, they cannot reach the image sensor 106 because they are greater than the critical angle of total reflection within the optical fiber. Therefore, part of scattered lights 504 from the object copy reach the image sensor, and picture information is outputted as a voltage.

### EMBODIMENT B3

FIG. 21 is a sectional structural diagram of an image detecting device in Embodiment B3 of the invention.

Second illuminating means 601 is arranged on the main face of the optical fiber array substrate constituting its plane of emission and in an area 602 positioned more towards the plane of emission than the area 502 opposite the plane of incidence.

Lights emitted from the second illuminating means are brought to incidence on the plane of incidence at an angle greater than the optical axis of the optical fiber.

Lights reflected by the object are powerfully emitted in a normal direction 503 where the Snell laws of refraction hold. Though these reflected lights are lights reflected from the object copy surface but not dependent on picture information, they cannot reach the image sensor 106 because they are greater than the critical angle of total reflection within the optical fiber. Therefore, part of scattered lights 504 from the object copy reach the image sensor, and picture information is outputted as a voltage.

The second illuminating means 601 is also the main face constituting the plane of emission of the optical fiber substrate, and is arranged in the area 602 positioned more towards the plane of emission than the area 502 opposite the plane of incidence. Lights emitted from the second illuminating means are brought to incidence on the plane of incidence substantially normally.

Lights reflected by the object are powerfully emitted in a direction 603 where the Snell laws of refraction hold, but these reflected lights do not reach the image sensor 106 either because they are greater than the critical angle of total reflection within the optical fiber.

Therefore, part of scattered lights 604 from the object copy reach the image sensor, and picture information is outputted as a voltage.

### EMBODIMENT B4

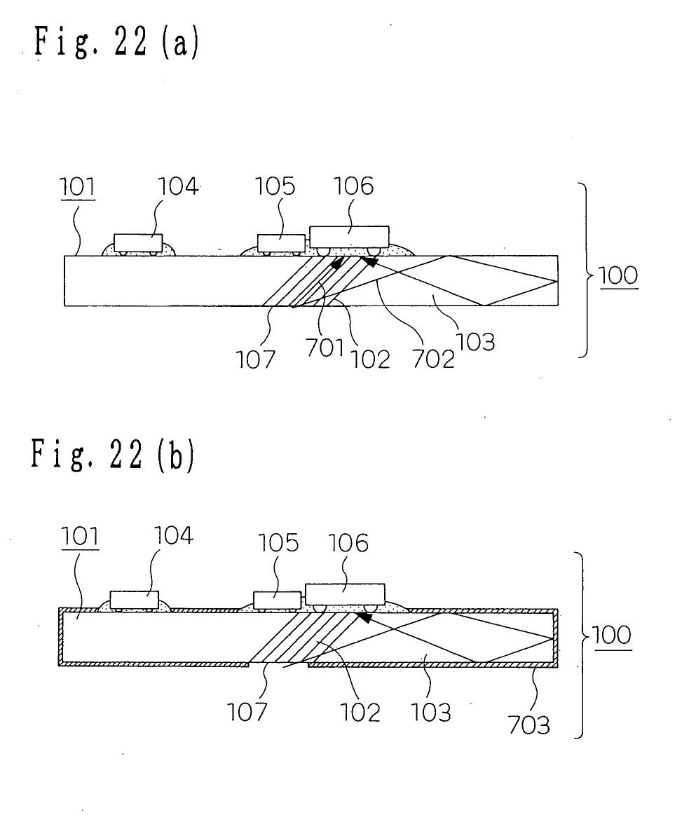

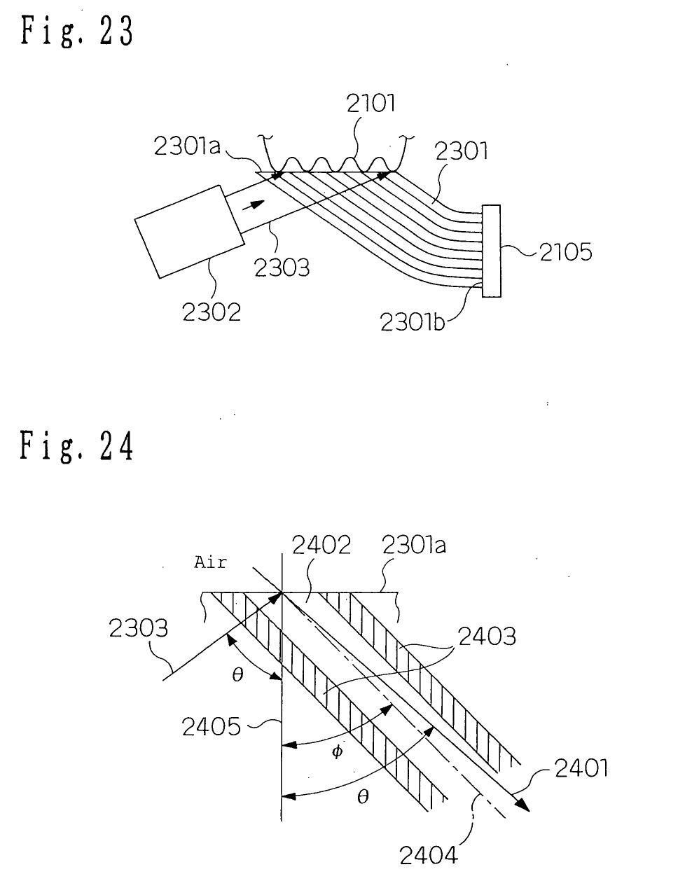

FIG. 22 is a sectional structural diagram of an image detecting device in Embodiment B4 of the invention. FIG. 22(a) shows part of scattered lights when second illuminating means is used.

Out of the lights radiated from the second illuminating means, while part 701 of scattered lights reflecting object copy information reach the image sensor 106 while being totally reflected within the optical fiber as stated earlier, the rest of the scattered lights propagate within the optical fiber substrate.

One example is denoted by 702 in FIG. 22(a). Such scattered lights are eventually emitted from the substrate, and partly come incident on the image sensor. Such lights greatly deteriorate the read quality as stray lights unmatched with object copy information.

FIG. 22(b) shows Embodiment B4 of the present invention. A light absorbing layer 703 is formed on the part of the surface of the optical fiber substrate except the area where the image sensor, the first illuminating means and the second illuminating means are to be arranged, the plane of incidence and the plane of emission. Stray lights were absorbed by this absorbing layer as they were reflected within the optical fiber, and the intensity of such lights reaching the image sensor became extremely small.

In order to further enhance the grade of printing by increasing absorption by this absorbing layer, it is desirable for the index of refraction of the absorbing layer 703 to be equal to the difference in the index of refraction of the base glass 102 of the optical fiber substrate or not more than 0.1 so that reflection between the base glass of the optical fiber substrate and the absorbing layer can be restrained.

As hitherto described, with the image detecting device according to the present invention, it is possible to detect, for instance in the incidence area, the unevenness pattern of the object and picture information on the surface of the object, and to obtain both of these items of detected information on a time-division basis. Thus, it is possible to satisfactorily obtain concave and convex information on an unevenness pattern and its picture information without having to package two image sensors, and to provide a small-sized and satisfactory image detecting device.

Essential inventive parts of the examples described mainly in respect of Embodiments A1 through A5 discussed above, which are related to the invention under the present application concerning an image detecting device and invented by the present inventor will be disclosed below.

Thus the essential inventive parts disclosed below (herein referred to simply as 1st through 20th related inventions as 1st through 20th inventions related to the present invention) were made in view of the first and second problems noted above, and are intended to provide a small-sized, planar and thin unevenness detecting sensor by using an optical plate having in part of a flat plate optical fibers of which the optical axes are inclined relative to the plane of incidence and providing an illuminating device and an optical detecting device on one face of the optical plate.

The first related invention is an optical plate characterized in that it has optical fibers in part of a flat plate and the optical axes of the optical fibers are not normal to the main face of the flat plate.

This configuration makes it possible to provide a fiber-containing optical plate which is planar and therefore thin, and can propagate lights totally reflected by the main face of the flat plate to the plane of emission of the fiber.

The second related invention is the optical plate of the first related invention characterized in that other parts of the flat plate than the fibers is formed of glass.

This configuration makes it possible to provide a relatively easy-to-manufacture and inexpensive fiber-containing optical plate which is susceptible to little variation in incident lights because of its proximity to the optical fiber in optical characteristics and can be readily joined with the optical fiber.

The third related invention is the optical plate of the first or second related invention characterized in that non-fiber parts and the fibers are directly bonded.

This makes it possible to provide a fiber-containing optical plate more readily moldable than where melt-bonding is used and unaffected by the adhesive layer.

The fourth related invention is the optical plate of the third related invention characterized in that the fibers and the non-fiber parts are joined by direct bonding via at least either of oxygen atoms and hydroxyl groups.

The fifth related invention is the optical plate of the first or second related invention characterized in that part of the flat plate consists of a light absorber.

This configuration makes it possible to provide a fiber-containing optical plate permitting elimination of the influence of scattered lights from non-fiber parts.

The sixth related invention is the optical plate of the first of second related invention characterized in that part of the flat plate consists of a light reflector.

This makes it possible to provide a fiber-containing optical plate permitting elimination of the influence of scattered lights from non-fiber parts.

The seventh invention is the optical plate of the first or second related invention characterized in that part of the flat plate has other optical fibers.

This makes it possible to provide a fiber-containing optical plate permitting elimination of the influence of scattered lights.

The eighth related invention is the optical plate of any one of the first through sixth related inventions characterized in that it has the fibers over the full width of the optical plate in the widthwise direction and the fibers only partially in the lengthwise direction.

The ninth related invention is an unevenness detecting sensor characterized in that it has the optical plate of the first related invention, an illuminating device provided on the main face of the optical plate, and a photoelectric converting device (e.g. an image sensor) provided over the output faces of the fibers of the optical plate.

This makes it possible to provide a planar, thin and small-sized unevenness detecting sensor over whose main face are packaged an illuminating device and a photoelectric converting device.

The 10th related invention is an unevenness detecting sensor characterized in that it has the optical plate of the fifth related invention, an illuminating device provided on the main face of the optical plate, and a photoelectric converting device provided over the output faces of the fibers of the optical plate, characterized in that the light absorber of the optical plate is provided on the reverse side to the illuminating device with respect to the photoelectric converting device.

This makes it possible to provide an unevenness detecting sensor excelling in resolution of detection because stray lights entering into the photoelectric converting device can be reduced by absorbing scattered lights from the surroundings of the photoelectric converting device and the detectable contrast is thereby increased.

The 11th related invention is an optical plate provided with the optical plate of the fifth related invention, an illuminating device provided on the main face of the optical plate, and a photoelectric converting device provided over the output faces of the fibers of the optical plate, characterized in that the light absorber of the optical plate is provided on the same side as the illuminating device with respect to the photoelectric converting device.

This makes it possible to remove other lights than those totally reflected by the planes of incidence of the optical fibers, and thereby to provide an unevenness detecting sensor excelling in resolution of detection and little affected by scattered lights and the like.

The 12th related invention is an unevenness detecting sensor characterized in that the light absorber is so provided as to absorb other lights, out of the lights radiated by the illuminating device, than those totally reflected by the planes of incidence of the fibers.

This makes it possible to prevent other lights than totally reflected lights from entering into the fibers, and thereby to provide an unevenness detecting sensor excelling in resolution of detection and little affected by scattered lights and the like.

The 13th related invention is an unevenness detecting sensor provided with the optical plate of the fifth related invention, an illuminating device provided on the main face of the optical plate, and a photoelectric converting device provided over the output faces of the fibers of the optical plate, characterized in that the light reflector of the optical plate is provided on the same side as the illuminating device with respect to the photoelectric converting device.

This makes it possible for the reflector to limit the optical path of incident lights and to prevent other lights than totally reflected lights from entering into the fibers, and thereby to provide an unevenness detecting sensor excelling in resolution of detection and little affected by scattered lights and the like.

The 14th related invention is the unevenness detecting sensor of the 12th related invention characterized in that the light reflector is so provided that lights radiated from the illuminating device be reflected by the reflector and confined and become totally reflected lights on the plane of incidence of the fiber.

The 15th related invention is an unevenness detecting sensor provided with the optical plate of the sixth related invention, an illuminating device provided on the main face of the optical plate, and a photoelectric converting device provided over the output faces of the fibers of the optical plate, characterized in that the other fibers of the optical plate is provided at such an angle that lights radiated from the illuminating device be totally reflected by the planes of incidence of the fibers.

This makes it possible for the fibers to limit the optical path of incident lights and to prevent other lights than totally reflected lights from entering into the fibers, and thereby to provide an unevenness detecting sensor excelling in resolution of detection and little affected by scattered lights and the like.

The 16th related invention is the unevenness detecting sensor according to any one of the 9th through 15th related inventions characterized in that the optical axes of the optical fibers are installed at such an angle to the normal to the main face that the critical angle of total reflection (e.g. θc) at which illuminating lights from the illuminating device are totally reflected by the main face of the optical plate and the angle (e.g. θa) to the normal to the main face at which incident lights are transmitted within the optical fiber substantially coincide with each other.

This makes it possible to achieve a high efficiency of the use of lights from the illuminating means and to obtain an unevenness pattern picture having a wide difference in gradation and a high contrast.

The 17th related invention is the unevenness detecting sensor according to any one of the 9th through 16th related inventions characterized in that the light radiating face of the illuminating device is joined to the main face of the optical plate with a resin intervening in-between.

This makes it possible for lights to be introduced into the optical plate without being reflected by the surface of the optical plate.

The 18th related invention is the unevenness detecting sensor according to any one of the 9th through 16th related inventions characterized in that the illuminating device is installed over the optical guide plate provided on the main face of the optical plate.

This makes it possible for lights to be uniformly introduced into the optical plate.

The 19th related invention is the unevenness detecting sensor according to any one of the 9th through 18th related inventions characterized in that the photoelectric converting device is joined to the main face of the optical plate with a resin having an index of refraction close to that of the core of the fiber intervening in-between.

This makes it possible, even if the photoelectric converting device is packaged over the flat plate, for lights not to be totally reflected by the planes of emission of the fibers but to be emitted from within the fibers to be introduced into the photoelectric converting device.

The 20th related invention is an unevenness detecting sensor provided with the optical plate and the illuminating device of the eighth related invention, an illuminating device provided on the main face of the optical plate, and a photoelectric converting device provided over the output faces of the fibers of the optical plate, characterized in that the number of channels is less than the number of channels of the photoelectric converting device.

This makes it possible to provide an unevenness detecting sensor which, though small in size and area, can reconstruct two-dimensional pictures.

### INDUSTRIAL APPLICABILITY

As is evident from what has been stated so far, the present invention can provide an advantage of being able to provide an image detecting device having both a function to detect the unevenness pattern of the object and a function to detect picture information on the object.

1. An image detecting device comprising:
an optical fiber array substrate penetrated by a plurality of optical fibers of each of which one end face is the plane of incidence and the other is the plane of emission, and in which said plurality of optical fibers are arranged, main face of said optical fiber array substrate being a face containing said plane of emission,
a circuit conductor layer formed on said main face, an image sensor arranged in a prescribed position on said circuit conductor layer,
first illuminating means so arranged as to make the angle of incidence of said optical fibers to said plane of incidence greater than a critical angle and a direction of lights reflected by said plane of incidence relative to a direction of the optical axes of said optical fibers not greater than a critical angle of total reflection within the optical fibers,
second illuminating means so arranged as to make the angle of incidence of said optical fibers to said plane of incidence smaller than the critical angle and the direction of lights reflected by said plane of incidence relative to the direction of the optical axes of said optical fibers not smaller than the critical angle of total reflection within the optical fibers, and
control means of performing control regarding turning on or off of said first and second illuminating means, wherein:
the direction of the optical axes of said optical fibers is arranged with an inclination by a prescribed angle to the normal to said main face of said optical fiber array substrate.

2. The image detecting device according to claim 1 wherein:
when only illuminating lights from said first illuminating means are caused to irradiate said plane of incidence by said control means, said image detecting device detects an unevenness pattern in which reflected lights from concaves of the unevenness pattern of an object of detection are more intense than reflected lights from convexes, said object of detection contacting with said plane of incidence.

3. The image detecting device according to claim 1 or 2 wherein:
said first illuminating means is packaged face down over said main face with optically transmissive insulating resin intervening in-between.

4. The image detecting device according to claim 1 wherein:
when only illuminating lights from said second illuminating means are caused to irradiate said plane of incidence by said control means, said image detecting device detects reflected lights corresponding to gradation of unevenness pattern of an object of detection, said object of detection contacting with said plane of incidence.

5. The image detecting device according to claim 1 or 2 wherein:
said second illuminating means is packaged face down over said main face with an optically transmissive insulating resin intervening in-between.

6. The image detecting device according to claim 1 wherein:
said control means selectively irradiates the planes of incidence of the optical fibers with illuminating lights from said first illuminating means and lights from said second illuminating means on a time-division basis.

7. The image detecting device according to any of claims 1 to 6 wherein:
said first illuminating means is arranged in a position away from a position on said main face opposite a substantially central position of said plane of incidence of said optical fiber array substrate by distance at least d×tan θ in the direction reverse to said plane of emission,
where d is the thickness of said optical fiber array substrate and θ is the critical angle of said optical fibers on said planes of incidence.

8. The image detecting device according to any of claims 1 to 6 wherein:
said second illuminating means is arranged in an area towards said plane of emission with reference to the position on said main face opposite the substantially central position of said plane of incidence of said optical fiber array substrate.

9. The image detecting device according to any of claims 1 to 8 wherein:
a light absorbing layer is formed over the surface of areas except an area in which said image sensor, said first illuminating means and said second illuminating means are arranged and an area of said plane of incidence and the plane of emission.

10. The image detecting device according to claim 8 wherein:
difference between an index of refraction of said absorbing layer and an index of refraction of said base ass of said optical fiber array substrate is not more an 0.1.

11. The image detecting device according to any of claims 1 to 10 wherein:
an angle formed by the direction of the optical axes of said optical fibers to said normal to the plane of incidence has a relationship of being smaller than an angle of reflection of lights emitted from said first illuminating means by said plane of incidence.
